(19) United States
(12) Patent Application Publication
(10) Pub. No.: US 2018/0028017 A1
(43) Pub. Date: Feb. 1, 2018

(54) GRILL PAN STRUCTURE

(71) Applicant: Ming-Yuan WU, Taipei City (TW)

(72) Inventor: Ming-Yuan WU, Taipei City (TW)

(21) Appl. No.: 15/220,274

(22) Filed: Jul. 26, 2016

(51) Int. Cl. A47J 37/06

(52) U.S. Cl. CPC A47J 37/067

(57) ABSTRACT

A grill pan structure with convection heating is provided to make uniformly heating within the oven. The grill pan structure includes a heat flow layer and at least one support plate. The heat flow layer includes at least one hole for a heat source to pass through for roasting. Also, the heat flow layer includes at least one recess to receive the dropped oils of the foods during roasting. The first support plate further includes at least one inclined guiding surface to guide the dropped oil to the recess. Therefore, uniformly heating for roasting foods and eliminate from turning over the foods during roasting are achieved. And the oven is still clean after roasting, which is convenient to use.

### BACKGROUND OF THE INVENTION

### Field of Invention

The present invention relates to a grill pan, and more particularly, but not exclusively to a grill pan structure, suitable for kinds of foods, to prevent to turn over the foods during roasting and easy to clean.

### Related Art

In general, when baking foods, if placed on a flat pan, it often produces uneven heating of the upper and lower sides. Since the flat pan dose not have openings, which the heat could not pass through, the surface of the foods, attached to the pan, is over/poor heating. Also, the oils generated from foods during heating will remain in the pan. The food may be spoiled after prolonged heating. And if baking a variety of foods at the same time, the generated oils will contaminate other foods. It is not only unhealthy but also affect food flavor.

If the grill grid is used to support the foods, the foods can be heated more evenly. However, the generated oils will drip into the baking device. It is dangerous and not easy to clean. Moreover, when uneven heating, it may have to extend the baking time or turn over the foods repeatedly. It wastes of resources and is not convenient to use.

For the conventional pan, it is usually plat and dish-shaped. The heat generated form the below heat source is not easy to reach the foods, because the heat cannot pass through the pan. Therefore, the heat efficiency is very low. It needs more time to finish baking. The time and the energy are wasted. Therefore, there is a need to improve the pan of the oven.

### SUMMARY OF THE INVENTION

The present invention overcomes the above-described and other problems and disadvantages in the conventional grill pan by providing a grill pan structure to heat foods uniformly within the oven.

Accordingly, the present invention provides a grill pan structure, includes a heat flow layer and at least one support plate. The heat flow layer includes at least one hole for a heat source to pass through to make uniformly heating and eliminate from turning over the foods. Also, the heat flow layer includes at least one recess to receive the dropped oils of the foods during roasting to keep the oven clean.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus are not limitative of the present invention, and wherein:

FIG. 1A is a schematic view of a first embodiment of the grill pan structure of the present invention;

FIG. 1B is an exploded view of a first embodiment of the grill pan structure of the present invention;

FIG. 2 is a cross-sectional view of a first embodiment of the grill pan structure of the present invention;

FIG. 3 is a schematic view of a second embodiment of the grill pan structure of the present invention;

FIG. 4 is a schematic view of a third embodiment of the grill pan structure of the present invention;

FIG. 5A is a schematic view of another example of the first embodiment of the grill pan structure of the present invention;

FIG. 5B is an exploded view of another example of the first embodiment of the grill pan structure of the present invention; and

FIGS. 6A and 6B are schematic views of the grill pan structure of the present invention when combined with an oven.

### DETAILED DESCRIPTION OF THE INVENTION

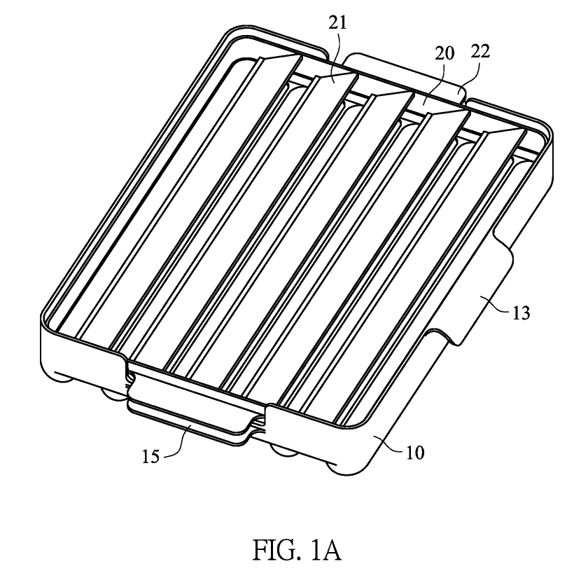

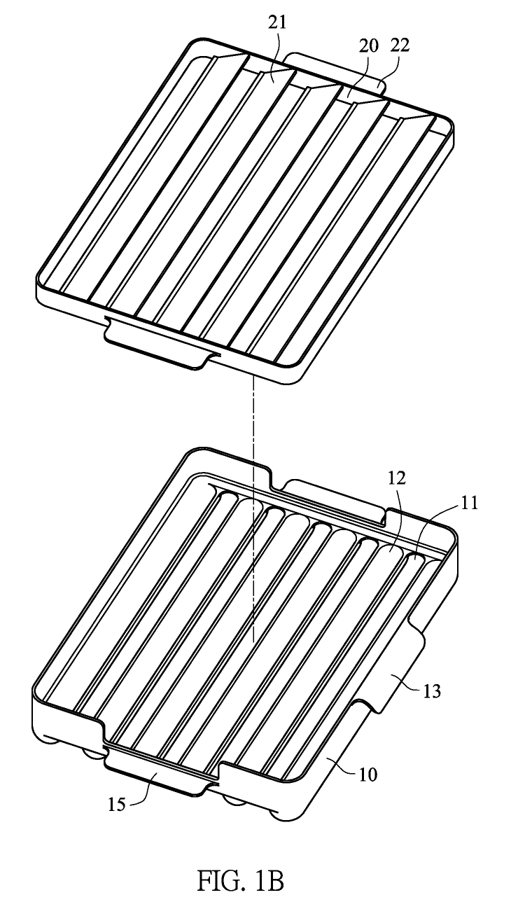

Please refer to FIG. 1A, a schematic view of a first embodiment of the grill pan structure of the present invention is shown.

The grill pan structure of the present invention is adapted to support an item for roasting. The grill pan includes a heat flow layer 10 and a first support plate 20. The heat flow layer 10 further includes at least one hand grip 13 and at least one protruding portion 15 disposed on a suitable location of the side thereof. The heat flow layer 10 also includes at least one hole 11 for a heat source to pass through and at least one recess 12 to receive a dropped oil of the item during roasting. The first support plate 20 is disposed on the heat flow layer 10 to support the item. The first support plate 20 also has at least one hand grip 22 disposed on a suitable location of the side thereof. The first support plate 20 includes at least one inclined guiding surface 21 corresponding to the recess 12 and guiding the dropped oil to the recess 12. FIG. 1B is an exploded view of a first embodiment of the grill pan structure of the present invention.

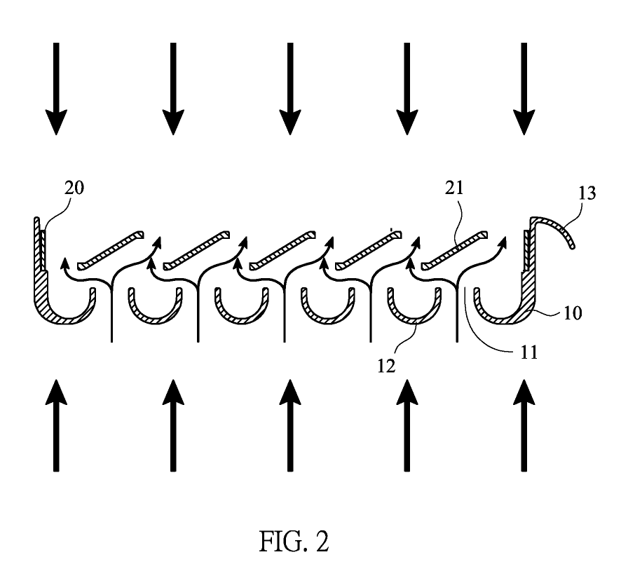

FIG. 2 is a cross-sectional view of a first embodiment of the grill pan structure of the present invention.

As shown in FIG. 2, the grill pan structure of the present invention includes the heat flow layer 10 and the first support plate 20. The item is supported by the first support plate 20. The above heat source may heat the item directly. And the below heat source may pass through the hole 11 of the heat flow layer 10 to heat the item. The dropped oil of the item during roasting would be guided by the inclined guiding surface 21 to the recess 12.

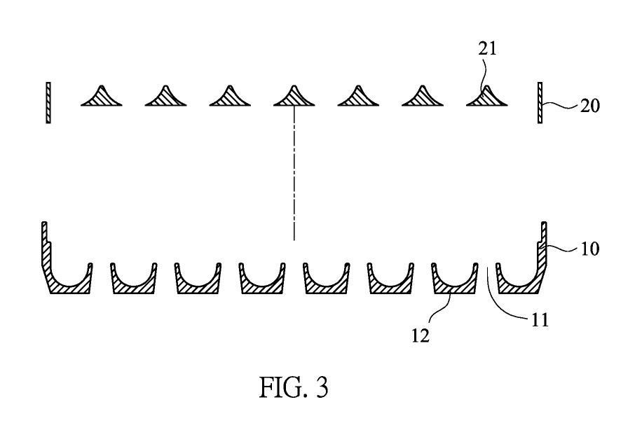

Please refer to FIG. 3, a schematic view of a second embodiment of the grill pan structure of the present invention is shown. As shown, the grill pan structure of the present invention includes the heat flow layer 10 and the first support plate 20. The heat flow layer 10 includes at least one hole 11 for a heat source to pass through and at least one recess 12 to receive a dropped oil of the item during roasting. The bottom of the first support plate 20 is flat to easy to place. The first support plate 20 is disposed on the heat flow layer 10 to support the item. The first support plate 20 also has at least one hand grip disposed on a suitable location. The first support plate 20 includes at least one cone-shaped inclined guiding surface 21 corresponding to the recess 12 and guiding the dropped oil to the recess 12.

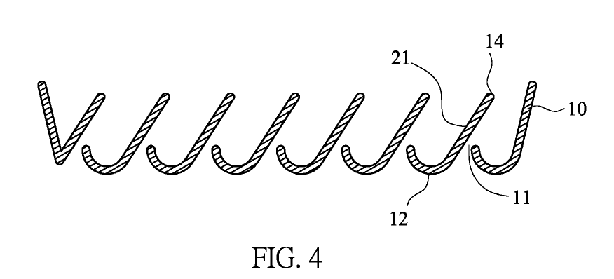

Please refer to FIG. 4, a schematic view of a third embodiment of the grill pan structure of the present invention is shown. The grill pan structure of this embodiment is integrated and includes the heat flow layer 10. The heat flow layer 10 includes at least one hole 11 for a heat source to pass through and at least one recess 12 to receive a dropped oil of the item during roasting. Moreover, the heat flow layer 10 includes a plurality of supporting ridges 14 to support the item. The inclined guiding surface 21 is extended from the supporting ridges 14 and integrated with the recess 12 to guide the dropped oil to the recess 12.

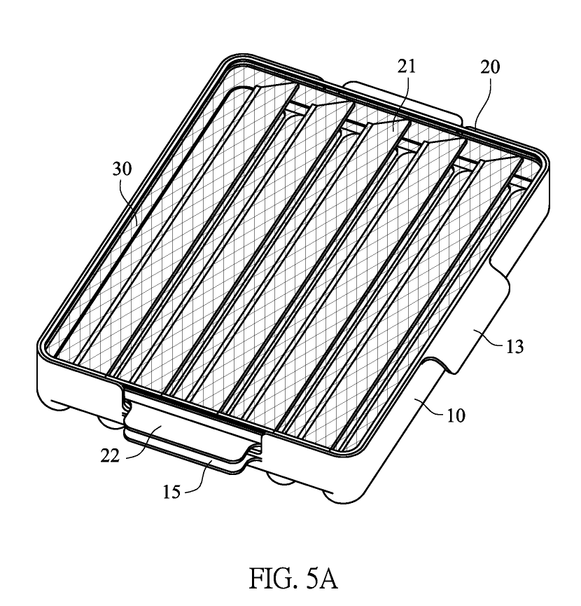

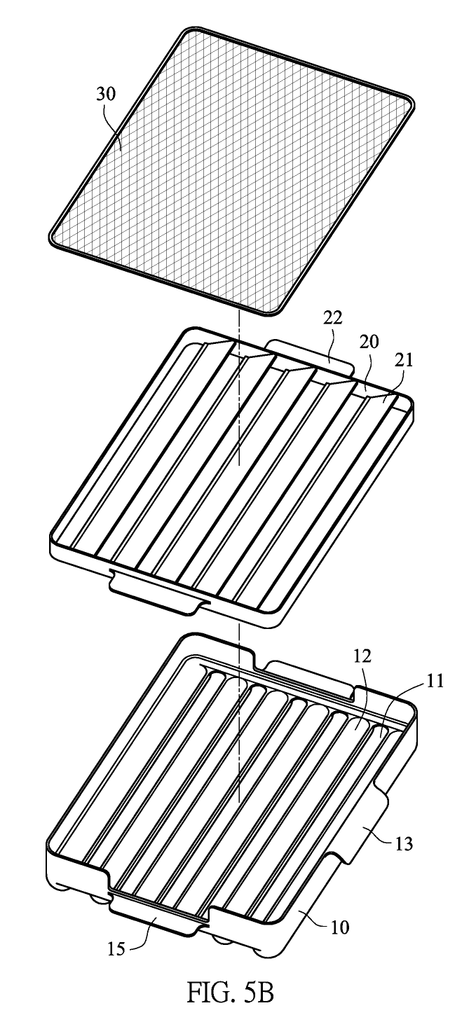

Please refer to FIG. 5A, a schematic view of another example of the first embodiment of the grill pan structure of the present invention is shown. The structure of this example is the same with the structure shown in FIG. 1A. The grill pan includes a heat flow layer 10 and a first support plate 20. The heat flow layer 10 further includes at least one hand grip 13 and at least one protruding portion 15 disposed on a suitable location of the side thereof. The heat flow layer 10 also includes at least one hole 11 for a heat source to pass through and at least one recess 12 to receive a dropped oil of the item during roasting. The first support plate 20 is disposed on the heat flow layer 10 to support the item. The first support plate 20 also has at least one hand grip 22 disposed on a suitable location of the side thereof. A second support plate 30 is disposed on the first support plate 20. As shown, the second support plate 30 has fine grids, which is suitable for small size foods. FIG. 5B is an exploded view of another example of the first embodiment of the grill pan structure of the present invention.

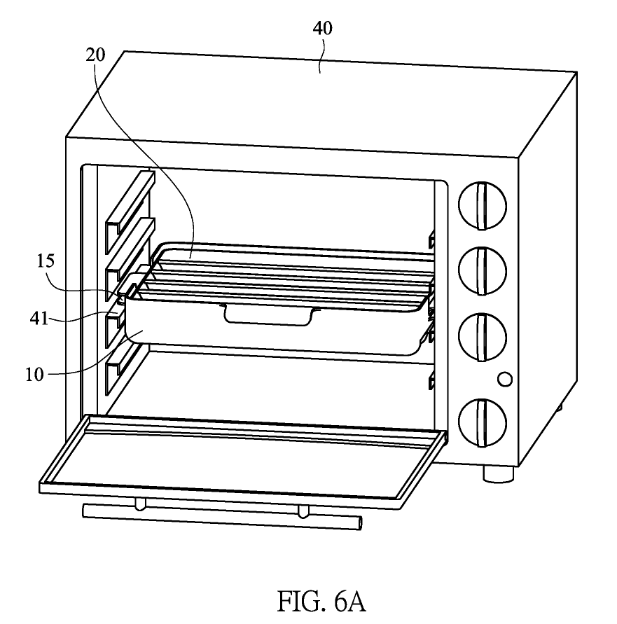

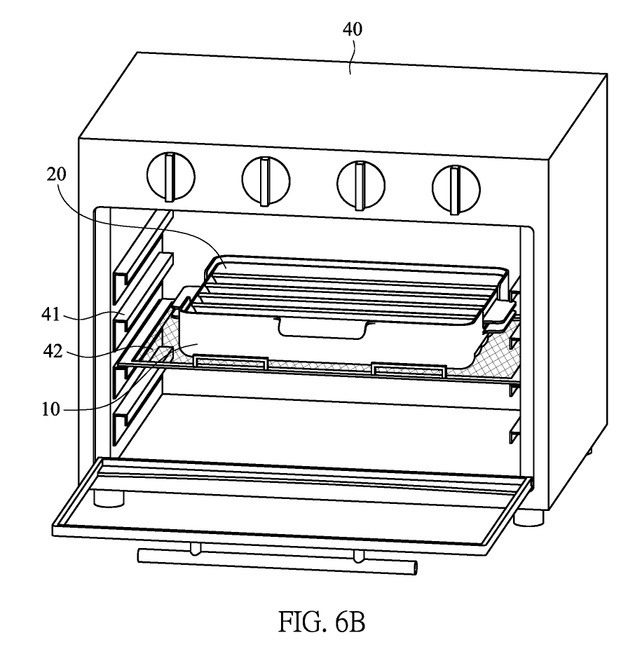

FIG. 6A is a schematic view of the grill pan structure of the present invention when combined with an oven. The protruding portion 15 of the heat flow layer 10 can be placed on the rack 41 of the oven 40 for normal use. Please see FIG. 6B, in case of the size of the heat flow layer 10 does not match the oven 40. The protruding portion 15 cannot be placed on the rack 41. The grill pan structure may be placed on the grid 42 of the oven 40 directly.

Accordingly, the present invention provides a grill pan structure to make the heat source pass through the grill pan for roasting uniform. Also, the oils may fully separate from the foods so that users would handle different foods at the same time without influencing with each other. The convenience of cooking is improved due to the convection heating to eliminate from turning over the foods and waiting aside. Also, seasonings may be add in the recess to smoke the foods during roasting.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A grill pan structure, adapted to support an item for roasting, the grill pan comprising:
a heat flow layer, including at least one hole for a heat source to pass through and at least one recess to receive a dropped oil of the item during roasting; and
a first support plate, disposed on the heat flow layer to support the item.

2. The grill pan of claim 1, wherein the first support plate includes at least one inclined guiding surface corresponding to the recess and guiding the dropped oil to the recess.

3. The grill pan structure of claim 1, wherein the heat flow layer further comprising at least one hand grip disposed on a side thereof.

4. The grill pan structure of claim 1, wherein the heat flow layer further comprising at least one protruding portion disposed on a side thereof.

5. The grill pan structure of claim 1, further comprising a second support plate disposed on the first support plate.

6. A grill pan structure, adapted to support an item for roasting, the grill pan comprising a heat flow layer, including at least one hole for a heat source to pass through, at least one recess to receive a dropped oil of the item during roasting, and a plurality of supporting ridges to support the item.

7. The grill pan of claim 1, wherein the supporting ridges includes at least one inclined guiding surface corresponding to the recess and guiding the dropped oil to the recess.

8. The grill pan structure of claim 6, wherein the heat flow layer further comprising at least one hand grip disposed on a side thereof.

9. The grill pan structure of claim 6, wherein the heat flow layer further comprising at least one protruding portion disposed on a side thereof.

10. The grill pan structure of claim 6, further comprising a second support plate disposed on the supporting ridges.
